(19) United States
(12) Patent Application Publication
(10) Pub. No.: US 2025/0036116 A1
(43) Pub. Date: Jan. 30, 2025

(54) SYSTEM AND METHOD FOR CALCULATING STATUS SCORE BASED ON TENSOR

(71) Applicant: SIMPLATFORM CO., LTD, Seoul (KR)

(72) Inventors: Min Sang KIM, Seoul (KR); Hong Gyu RYU, Seoul (KR)

(21) Appl. No.: 18/914,043

(22) Filed: Oct. 11, 2024

Related U.S. Application Data
(63) Continuation of application No. PCT/KR2023/003705, filed on Mar. 21, 2023.

(30) Foreign Application Priority Data
Apr. 12, 2022 (KR) 10-2022-0045035

(51) Int. Cl. G05B 23/02

(52) U.S. Cl. CPC G05B 23/0262

(57) ABSTRACT

A state score derivation system includes a normal-state matrix generation unit configured to receive process data in a normal state for a plurality of points in time and generate a two-dimensional (2D) normal-state matrix representative of the relationship between the data values of a current point in time and a previous point in time for each point in time; a process data reception unit configured to receive process data; a checking target matrix generation unit configured to periodically check the received process data and generate a 2D checking target matrix representative of the relationship between the data values of a current point in time and a previous point in time for each period; and a state score derivation unit configured to derive a state score.

### CROSS-REFERENCE TO RELATED APPLICATIONS

This application is a Continuation of International Application No. PCT/KR2023/003705 filed Mar. 21, 2023, which claims priority from Korean Application No. 10-2022-0045035 filed Apr. 12, 2022. The aforementioned applications are incorporated herein by reference in their entireties.

### TECHNICAL FIELD

The present invention relates to a tensor-based state score derivation system and method, and more particularly to a system and method that can determine whether a current state is abnormal by using only normal-state data in the state where there is no training data in which data in a normal state and data in an abnormal state are distinguished from each other.

### RELATED ART

With the development of artificial intelligence technology, there is being activated smart factory technology that can monitor various types of information of a process or equipment with sensors and detect or predict abnormal states based on artificial intelligence, thereby increasing process efficiency and minimizing the effort required for management.

Korean Patent No. 10-0570528 entitled “Process Equipment Monitoring System and Model Generation Method,” which is a conventional art, proposes a system that can determine an abnormal state of process equipment by using artificial intelligence. In order to manage a process by using artificial intelligence, data derived from each process needs to be analyzed and an artificial intelligence model needs to be set up through training.

However, to this end, it is necessary to prepare training data in which data in a normal state and data in an abnormal state are distinguished from each other for each process or each piece of equipment. The process of distinguishing data by state is called labeling. However, in many cases, equipment does not often cause errors in its initial operation. Furthermore, in order to deal with situations in which an error occurs due to aging or the like, there must be cases in which such situations have occurred. Accordingly, there is a difficulty securing data in an abnormal state other than data in a normal state for training.

Therefore, there is a demand for a method of preparing training data for boundary derivation that, without data in an abnormal state, extracts the boundary of data in a normal state and enables a state in question to be classified as a normal state or an abnormal state depending on the value of corresponding data based on the boundary.

### SUMMARY

An object of the present invention is to enable a process risk state to be represented numerically by using only normal-state data even when there is no abnormal state-related training data.

An object of the present invention is to enable a process state to be accurately determined by analyzing changes in periodic sensing values.

An object of the present invention is to enable a process state to be quantified without abnormal state-related training data even when various types of process data are input.

An object of the present invention is to enable more accurate state calculation by dividing normal-state data into multiple sections and allocating a greater weight to a cell having a smaller deviation for each section.

In order to accomplish the above object, a state score derivation system according to an embodiment of the present invention may be configured to include: a normal-state matrix generation unit configured to receive process data in a normal state for a plurality of points in time and generate a two-dimensional (2D) normal-state matrix representative of the relationship between the data values of a current point in time and a previous point in time for each point in time; a process data reception unit configured to receive process data; a checking target matrix generation unit configured to periodically check the received process data and generate a 2D checking target matrix representative of the relationship between the data values of a current point in time and a previous point in time for each period; and a state score derivation unit configured to derive a state score by calculating a value representative of the difference between the normal-state matrix and the checking target matrix.

In this case, the normal-state matrix generation unit and the checking target matrix generation unit may determine sections, within which the data values of the current point in time and the previous point in time fall, among predetermined n sections, and may generate an n*n matrix with the section within which the data value of the current point in time falls and the section within which the data value of the previous point in time falls used as respective axes by using information about the sections within which the process data values of the current point in time and the previous point in time fall.

Furthermore, the normal-state matrix generation unit may generate a plurality of pieces of sub-process data by dividing the plurality of points in time by a time unit, may generate a 2D normal-state sub-matrix for each of the pieces of sub-process data, and may calculate a weight for each intra-matrix cell by comparing the normal-state matrix and the plurality of normal-state sub-matrices; and the state score derivation unit may calculate the difference between the normal-state matrix and the checking target matrix by reflecting the calculated weight for each intra-matrix cell therein.

Furthermore, the normal-state matrix generation unit may calculate the difference between the values of corresponding cells between the normal-state matrix and each of the plurality of normal-state sub-matrices, and may calculate the weight for each cell so that as the deviation of the calculated difference between the values decreases, a higher weight is allocated.

Moreover, the normal-state matrix generation unit and the checking target matrix generation unit may generate 2D matrices for different types of process data, and the state score derivation unit may derive a state score by adding up the differences between a normal-state matrix and a checking target matrix generated for each type of process data.

The present invention has the effect of enabling a process risk state to be represented numerically by using only normal-state data even when there is no abnormal state-related training data.

The present invention has the effect of enabling a process state to be accurately determined by analyzing changes in periodic sensing values.

The present invention has the effect of enabling a process state to be quantified without abnormal state-related training data even when various types of process data are input.

The present invention has the effect of enabling more accurate state calculation by dividing normal-state data into multiple sections and allocating a greater weight to a cell having a smaller deviation for each section.

### BRIEF DESCRIPTION OF THE DRAWINGS

FIG. 1 is a block diagram showing the internal configuration of a state score derivation system according to an embodiment of the present invention;

FIG. 2 is a diagram showing a process of generating a normal-state matrix and a checking target matrix in the state score derivation system of the present invention;

FIG. 3 is a drawing showing an example of deriving a state score by comparing a normal-state matrix and a checking target matrix in a state score derivation system according to an embodiment of the present invention;

FIG. 4 is a diagram showing an example of calculating per-cell weights by using normal-state process data in a state score derivation system according to an embodiment of the present invention; and

FIG. 5 is a flowchart showing the flow of a state score derivation method according to an embodiment of the present invention.

### DETAILED DESCRIPTION

In order to accomplish the above object, a state score derivation system according to an embodiment of the present invention may be configured to include: a normal-state matrix generation unit configured to receive process data in a normal state for a plurality of points in time and generate a two-dimensional (2D) normal-state matrix representative of the relationship between the data values of a current point in time and a previous point in time for each point in time; a process data reception unit configured to receive process data; a checking target matrix generation unit configured to periodically check the received process data and generate a 2D checking target matrix representative of the relationship between the data values of a current point in time and a previous point in time for each period; and a state score derivation unit configured to derive a state score by calculating a value representative of the difference between the normal-state matrix and the checking target matrix.

In this case, the normal-state matrix generation unit and the checking target matrix generation unit may determine sections, within which the data values of the current point in time and the previous point in time fall, among predetermined n sections, and may generate an n*n matrix with the section within which the data value of the current point in time falls and the section within which the data value of the previous point in time falls used as respective axes by using information about the sections within which the process data values of the current point in time and the previous point in time fall.

Furthermore, the normal-state matrix generation unit may generate a plurality of pieces of sub-process data by dividing the plurality of points in time by a time unit, may generate a 2D normal-state sub-matrix for each of the pieces of sub-process data, and may calculate a weight for each intra-matrix cell by comparing the normal-state matrix and the plurality of normal-state sub-matrices; and the state score derivation unit may calculate the difference between the normal-state matrix and the checking target matrix by reflecting the calculated weight for each intra-matrix cell therein.

Furthermore, the normal-state matrix generation unit may calculate the difference between the values of corresponding cells between the normal-state matrix and each of the plurality of normal-state sub-matrices, and may calculate the weight for each cell so that as the deviation of the calculated difference between the values decreases, a higher weight is allocated.

Moreover, the normal-state matrix generation unit and the checking target matrix generation unit may generate 2D matrices for different types of process data, and the state score derivation unit may derive a state score by adding up the differences between a normal-state matrix and a checking target matrix generated for each type of process data.

Hereinafter, preferred embodiments of the present invention will be described in detail with reference to the accompanying drawings. In the description of the present invention, when it is determined that a detailed description of a related known configuration or function may obscure the gist of the present invention, the detailed description will be omitted. Furthermore, in the description of the embodiments of the present invention, specific numerical values are merely examples, and the scope of the invention is not limited thereby.

A state score derivation system according to the present invention may be configured in the form of a server equipped with a central processing unit (CPU) and memory (a storage device) and capable of being connected to another terminal over a communication network such as the Internet. However, the present invention is not limited by the configurations of the central processing unit and the memory. Furthermore, the state score derivation system according to the present invention may be configured as a physically single apparatus, or may be implemented in a distributed form across a plurality of apparatuses.

In the present invention, the process may refer to a production or manufacturing process that produces products by using equipment and facilities, or may refer to various cases of maintaining and operating equipment or facilities. Accordingly, in the present invention, the process data may include various types of state information sensed from various types of equipment and facilities, and the invention is not limited by the types.

In the present invention, the state score indicates the degree of risk that the state of a process has compared to a normal state, and a higher state score is interpreted as indicating a higher risk having a higher possibility of becoming an abnormal state.

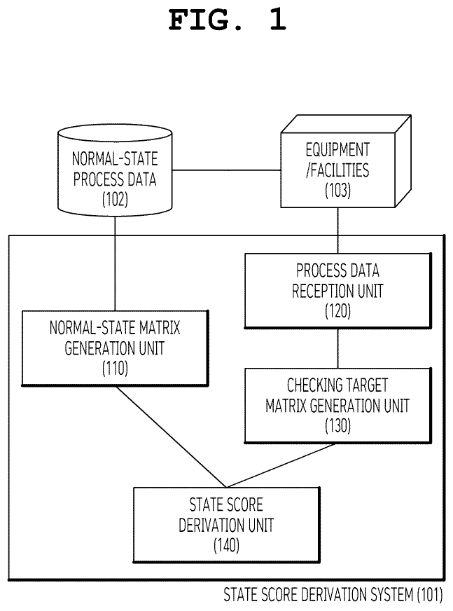

FIG. 1 is a block diagram showing the internal configuration of a state score derivation system according to an embodiment of the present invention.

As shown in the drawing, a state score derivation system 101 according to an embodiment of the present invention may be configured to include a normal-state matrix generation unit 110, a process data reception unit 120, a checking target matrix generation unit 130, and a state score derivation unit 140. The individual components may be software modules operating within a physically identical computer system, and may be configured to allow two or more physically separated computer systems to operate in conjunction with each other. Various embodiments including the same functions fall within the scope of the present invention.

The normal-state matrix generation unit 110 receives normal-state process data for a plurality of points in time, and generates a 2D normal-state matrix representative of the relationship between the data values of a current point in time and a previous point in time for each point in time. The process data refers to sensing data collected from the equipment of a factory, facilities, or various on-site apparatuses, and may be any data as long as the data can be used to determine the state of the equipment and facilities of a process. Furthermore, the above-described process data is the data that is continuously or periodically input over time, and allows the state of equipment and facilities to be analyzed through changes in values attributable to time-series changes.

The normal-state process data received by the normal-state matrix generation unit 110 refers to the data input during the period for which equipment or facilities are operating normally among process data. In order to secure sufficient data for analysis, it is desirable to utilize data accumulated for as long as possible. The normal-state process data may be the data input in real time, but it may also be possible to store data during an operation in a normal state in the past in a separate database 102 and utilize it.

The normal-state matrix generation unit 110 may determine the sections, within which the data values of a current point in time and a previous point in time fall, among predetermined n sections, and may generate an n*n matrix with the section within which the data value of the current point in time falls and the section within which the data value of the previous point in time falls used as respective axes by using information about the sections within which the process data values of the current point in time and the previous point in time fall. As described above, when process data is continuously or periodically input, data values may be checked and analyzed at a plurality of points in time at set time intervals. For example, when data for ten hours in a normal-state operation is checked at one-minute intervals, a total of 600 values may be checked, and a 2D normal-state matrix is generated using these values.

The sections for the analysis of data values in the normal-state matrix generation unit 110 may be set differently depending on the characteristics of the data. In order to obtain more effective analysis results, it is desirable to attempt various types of section setting and find an optimal section setting method. For example, when the voltage value in a normal state has one value between 0 V and 50 V, there is a possibility that a value outside the range may be input in an abnormal state. Accordingly, the range may be set to a more generous range from 0 V to 100 V, and this range may be divided into ten sections at 10 V intervals.

As described above, the matrix is constructed by checking a change between the data values of a current point in time and a previous point in time for each point in time, so that a 2D matrix is generated such that the number of sections becomes the size of rows/columns. In the case where the range is set to ten sections as in the previous example, a 10×10 2D matrix may be constructed.

In the normal-state matrix generation unit 110, a 2D matrix is set according to the number of sections, all the values are initially set to 0, and coordinate values corresponding to the sections within which the data values of a corresponding point in time and a previous point in time fall are each increased by one for each point in time. In this case, the current point in time may be configured as a row and the previous point in time may be configured as a column, and it may also be possible to configure the current point in time as a column and the previous point in time as a row.

Once the normal-state matrix generation unit 110 has primarily generated the matrix based on the values of the current point in time and the previous point in time for each of a plurality of points in time in this manner, it is necessary to perform normalization for each item of the overall matrix. The generated normal-state matrix is compared with a checking target matrix generated from actual real-time process data in the future. Since a difference occurs when the number of points in time used to generate the matrix is different, the frequency of each cell of each matrix may be compared as a normalized value through a normalization process. For example, a cell having the highest value may be set to 1 and a cell not counted at all may be set to 0, so that the value can be normalized between 0 and 1. Furthermore, various methods may be applied for normalization, but the present invention is not limited thereto.

The normal-state matrix generation unit 110 may divide the plurality of points in time by a time unit to generate a plurality of pieces of sub-process data, may generate a 2D normal-state sub-matrix for each sub-process data, and may compare the normal-state matrix and the plurality of normal-state sub-matrices to calculate a weight for each cell within the matrix. When all the items of the matrix are analyzed to derive the state, a specific item (a cell) may have a higher influence on the state, and a specific cell may not have a significant influence on the state. To reflect this difference, a weight is designated for each cell. For this purpose, the sub-process data generated by dividing the plurality of points in time by a time unit may be used.

In this case, the normal-state matrix generation unit 110 may calculate the difference between the values of corresponding cells between the normal-state matrix and each of the plurality of normal-state sub-matrices, and may calculate a weight for each cell so that, as the deviation of the difference between calculated values decreases, a larger weight is allocated.

For example, when normal-state data is for ten hours and there is data for a total of 600 points at one-minute intervals, it may be divided into five sections of two hours each, and a 2D matrix may be generated with 120 pieces of data for each section in the same manner. In this case, the value of a specific cell may fluctuate highly depending on the section, and a specific cell may have an almost constant value even when the section changes. When there is a large fluctuation in the normal-state data, it is highly likely that it will be difficult to play an appropriate role in detecting an abnormal state. Furthermore, when there is a large fluctuation in the value of a corresponding cell of a checking target matrix for a cell confirmed to have a similar frequency without a large fluctuation in the normal-state data, it is desirable to view the state as a high-risk state.

Accordingly, the normal-state matrix generation unit 110 may generate a plurality of normal-state sub-matrices and may calculate a weight for each cell by comparing the normal-state sub-matrices with a normal-state matrix for an overall section.

In addition, the normal-state matrix generation unit 110 may generate 2D matrices for different types of process data. In the foregoing description, there was described a case where one sensing result is input as process data for one piece of equipment or one facility. In the case where various types of sensing results are input, a 2D matrix may be generated for each, a three-dimensional (3D) matrix may be generated by accumulating 2D matrices, and they are compared to derive a state score. In order to simplify vector calculation in this manner, multiple vectors having the same property are expressed in one matrix, and what is obtained by simplifying the matrix is called a “tensor.”

The process data reception unit 120 receives process data. In this case, the process data may refer to various types of sensor data received from various types of equipment or facilities 103 as described above. The process data may be the data input in real time to calculate the state of the equipment or facilities 130 in a current state.

The process data reception unit 120 may be directly connected to the equipment or facilities 103 over a network or the like, or may receive data from a sensor attached to the equipment or facilities 103. In some cases, the process data reception unit 120 may also be configured to receive data from a database where past data is accumulated and analyze a past state.

The checking target matrix generation unit 130 periodically checks the received process data, and generates a 2D checking target matrix representative of the relationship between the data values of a current point in time and a previous point in time for each period.

The checking target matrix generation unit 130 may generate a 2D matrix in the same manner as the normal-state matrix generation unit 110, but the target data may be real-time process data collected in real time rather than normal-state process data. Through this, the differences between the process data input in real time and the normal-state process data may be quantified, and a state score may be derived accordingly.

Even when there is no separate description, the operation method of the normal-state matrix generation unit 110 may be applied as a method of generating a 2D matrix in the checking target matrix generation unit 130 without change.

The state score derivation unit 140 derives a state score by calculating a value representative of the difference between the normal-state matrix and the checking target matrix. Through this, the difference between the matrix generated with the normal-state process data and the matrix generated for the process data input in real time is quantified. As the difference increases, the state may be viewed as being close to an abnormal state because it is considered to be different from a normal state, and it may be interpreted as having a high state score.

In order to quantify the difference between the normal-state matrix and the checking target matrix in the state score derivation unit 140, various methods may be employed. The differences between the values of items at the same locations in the individual matrices may be simply added up or may be squared and then added up (the Euclidean distance), or other various methods may be applied thereto.

When the normal-state matrix generation unit 110 calculates the weight for each cell, the state score derivation unit 140 calculates the difference between the normal-state matrix and the checking target matrix by reflecting the calculated per-internal cell weight therein. A configuration may be made such that, when the weight for each cell is given, a case where the difference between cells having larger weights is larger has a larger state score. Through this, it may be possible to more accurately determine the state based on weights.

When the normal-state matrix generation unit 110 and the checking target matrix generation unit 130 generate 2D matrices for different types of process data, respectively, the state score derivation unit 140 may derive a state score by adding up the differences between a normal-state matrix and a checking target matrix generated for respective types of process data. When various types of sensing data are input in this manner, a comprehensive state score may be generated using the matrix obtained by accumulating the various types of sensing data, and it may be possible to rapidly prepare for the risk state of a process.

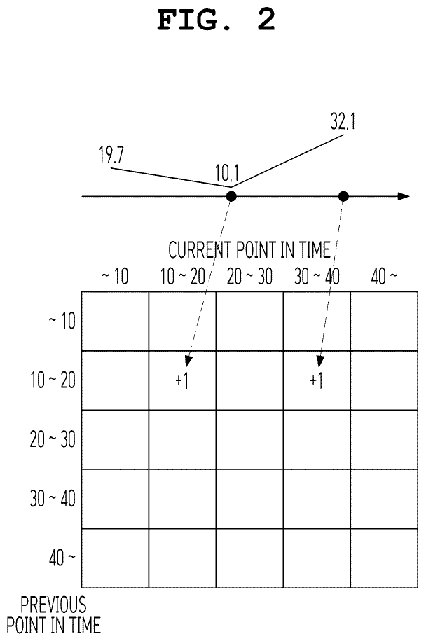

FIG. 2 is a diagram showing a process of generating a normal-state matrix and a checking target matrix in the state score derivation system of the present invention.

Assuming that as shown in the drawing, the value of the process data periodically checked at a plurality of points in time changes to 19.7, 10.1, and 32.1 and a range is divided into five sections of below 10, 10 to 20, 20 to 30, 30 to 40, and above 40, a value at a current point in time is 10.1 at a second point in time, so that it falls within the section of 10 to 20, and a value at a previous point in time is 19.7, so that it also falls within the section of 10 to 20. Accordingly, values corresponding to the coordinates of 10 to 20 and 10 to 20 in the matrix are each increased by one.

In the same manner, when viewed at a third point in time, a value at a current point in time is 32.1, which falls within the section of 30 to 40, and a value at a previous point in time is 10.1, which falls within the section of 10 to 20, so that the values corresponding to the coordinates of 30 to 40 and 10 to 20 are each increased by one.

In the case where all the values of an initial matrix are set to 0 to start with, when values change for the overall process data in this manner, a 2D matrix for the relationship between a current point in time and a previous point in time for each point in time is finally generated. When the matrix generated in this case is normalized, a 2D matrix that can be compared with another matrix may be generated.

In the present invention, the normal-state matrix and the checking target matrix may be generated in this manner, it may be possible to check how much the process data represented by the checking target matrix differs from normal-state data by comparing them with each other, and a state score may be calculated based on this.

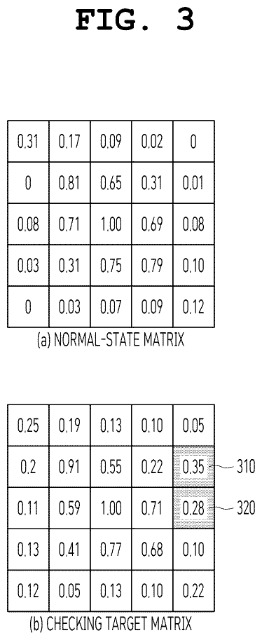

FIG. 3 is a drawing showing an example of deriving a state score by comparing a normal-state matrix and a checking target matrix in a state score derivation system according to an embodiment of the present invention.

As shown in the drawing, when a 5×5 2D matrix is generated for each of normal-state data and actual data and a normal-state matrix and a checking target matrix are generated, a state score may be obtained by comparing them. As the checking target matrix has more similar distribution to that of the normal-state matrix and is close to a normal state, a lower state is measured. In contrast, in the opposite case, a higher risk is measured.

In the drawing, the cells denoted by the reference symbols 310 and 320 are locations where the difference between the normal-state matrix and the checking target matrix is large. As the number of such cells increases, the state score appears higher.

In this case, when the weights of the cells corresponding to the reference symbols 310 and 320 are measured as higher values, the state score may be calculated to be higher. In contrast, when the weights are measured as lower values, the state score may be measured as a lower value. Accordingly, the result varies depending on how appropriately weights are set. In the present invention, the weights are determined by dividing and analyzing normal-state data in detail, so that a more accurate state score can be calculated.

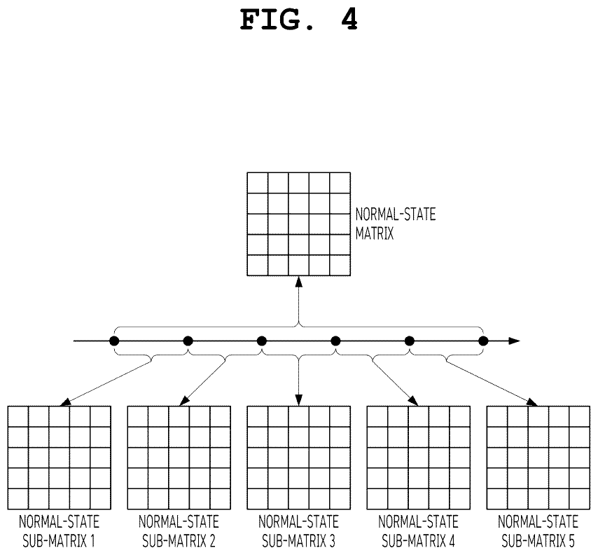

FIG. 4 is a diagram showing an example of calculating per-cell weights by using normal-state process data in a state score derivation system according to an embodiment of the present invention.

As shown in the diagram, first, a normal-state matrix is generated for the overall normal-state data, an overall section is divided into a set number (5 in the diagram) of sub-sections, and normal-state sub-matrices 1 to 5 are generated for the respective sub-sections.

The normal-state matrix is compared with each of the normal-state sub-matrices 1 to 5. In the case of a cell having the large deviation of a value in the sub-sections compared to the measured value of the overall section, even when the value of a checking target matrix having a large differences from the value of a normal-state matrix is input in the future, it is difficult to consider this to represent a high state. Accordingly, it is desirable to provide a low weight.

In contrast, when the deviation in each sub-matrix for a specific cell is not large, this is a cell that exhibits a stable value in a normal state. Accordingly, it is desirable to determine the state score to be high even when the value of the cell of the checking target matrix is slightly different.

Therefore, weights may be allocated through this method so that the state score can be more accurately determined.

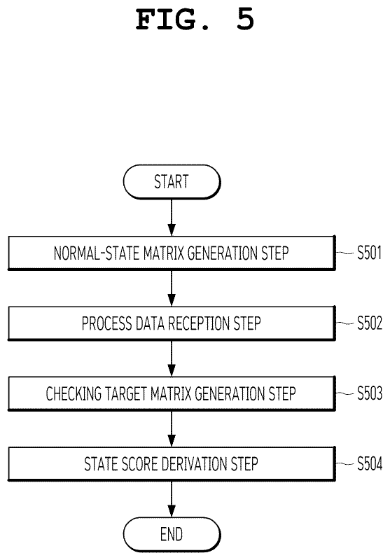

FIG. 5 is a flowchart showing the flow of a state score derivation method according to an embodiment of the present invention.

The state score derivation method according to the present invention is a method that operates in the state score derivation system 101 equipped with a central processing unit and memory, and may be executed in such a computing system.

Accordingly, the state score derivation method includes all the characteristic configurations described for the above-described state score derivation system 101, and the items that are not described in the following description may also be implemented by referring to the descriptions given for the above-described state score derivation system 101.

In a normal-state matrix generation step S501, normal-state process data is received for a plurality of points in time, and a 2D normal-state matrix representative of the relationship between the data values of a current point in time and a previous point in time for each point in time is generated. The process data refers to sensing data collected from the equipment of a factory, facilities, or various on-site apparatuses, and may be any data as long as the data can be used to determine the state of the equipment and facilities of a process. Furthermore, the above-described process data is the data that is continuously or periodically input over time, and allows the state of equipment and facilities to be analyzed through changes in values attributable to time-series changes.

The normal-state process data received in the normal-state matrix generation step S501 refers to the data input during the period for which equipment or facilities are operating normally among process data. In order to secure sufficient data for analysis, it is desirable to utilize data accumulated for as long as possible. The normal-state process data may be the data input in real time, but it may also be possible to store data during an operation in a normal state in the past in a separate database 102 and utilize it.

In the normal-state matrix generation step S501, the sections, within which the data values of a current point in time and a previous point in time fall, are determined among predetermined n sections, and an n*n matrix with the section within which the data value of the current point in time falls and the section within which the data value of the previous point in time falls used as respective axes may be generated using information about the sections within which the process data values of the current point in time and the previous point in time fall. As described above, when process data is continuously or periodically input, data values may be checked and analyzed at a plurality of points in time at set time intervals. For example, when data for ten hours in a normal-state operation is checked at one-minute intervals, a total of 600 values may be checked, and a 2D normal-state matrix is generated using these values.

The sections for the analysis of data values in the normal-state matrix generation step S501 may be set differently depending on the characteristics of the data. In order to obtain more effective analysis results, it is desirable to attempt various types of section setting and find an optimal section setting method. For example, when the voltage value in a normal state has one value between 0 V and 50 V, there is a possibility that a value outside the range may be input in an abnormal state. Accordingly, the range may be set to a more generous range from 0 V to 100 V, and this range may be divided into ten sections at 10 V intervals.

As described above, the matrix is constructed by checking a change between the data values of a current point in time and a previous point in time for each point in time, so that a 2D matrix is generated such that the number of sections becomes the size of rows/columns. In the case where the range is set to ten sections as in the previous example, a 10×10 2D matrix may be constructed.

In the normal-state matrix generation step S501, a 2D matrix is set according to the number of sections, all the values are initially set to 0, and coordinate values corresponding to the sections within which the data values of a corresponding point in time and a previous point in time fall are each increased by one for each point in time. In this case, the current point in time may be configured as a row and the previous point in time may be configured as a column, and it may also be possible to configure the current point in time as a column and the previous point in time as a row.

Once the matrix has been primarily generated based on the values of the current point in time and the previous point in time for each of a plurality of points in time in this manner in the normal-state matrix generation step S501, it is necessary to perform normalization for each item of the overall matrix. The generated normal-state matrix is compared with a checking target matrix generated from actual real-time process data in the future. Since a difference occurs when the number of points in time used to generate the matrix is different, the frequency of each cell of each matrix may be compared as a normalized value through a normalization process. For example, a cell having the highest value may be set to 1 and a cell not counted at all may be set to 0, so that the value can be normalized between 0 and 1. Furthermore, various methods may be applied for normalization, but the present invention is not limited thereto.

The normal-state matrix generation unit 110 may divide the plurality of points in time by a time unit to generate a plurality of pieces of sub-process data, may generate a 2D normal-state sub-matrix for each sub-process data, and may compare the normal-state matrix and the plurality of normal-state sub-matrices to calculate a weight for each cell within the matrix. When all the items of the matrix are analyzed to derive the state, a specific item (a cell) may have a higher influence on the state, and a specific cell may not have a significant influence on the state. To reflect this difference, a weight is designated for each cell. For this purpose, the sub-process data generated by dividing the plurality of points in time by a time unit may be used.

In this case, in the normal-state matrix generation step S501, the difference between the values of corresponding cells between the normal-state matrix and each of the plurality of normal-state sub-matrices may be calculated, and a weight for each cell may be calculated such that, as the deviation of the difference between calculated values decreases, a larger weight is allocated.

For example, when normal-state data is for ten hours and there is data for a total of 600 points at one-minute intervals, it may be divided into five sections of two hours each, and a 2D matrix may be generated with 120 pieces of data for each section in the same manner. In this case, the value of a specific cell may fluctuate highly depending on the section, and a specific cell may have an almost constant value even when the section changes. When there is a large fluctuation in the normal-state data, it is highly likely that it will be difficult to play an appropriate role in detecting an abnormal state. Furthermore, when there is a large fluctuation in the value of a corresponding cell of a checking target matrix for a cell confirmed to have a similar frequency without a large fluctuation in the normal-state data, it is desirable to view the state as a high-risk state.

Accordingly, in the normal-state matrix generation step S501, a plurality of normal-state sub-matrices may be generated, and a weight for each cell may be calculated by comparing the normal-state sub-matrices with a normal-state matrix for an overall section.

In addition in the normal-state matrix generation step S501, 2D matrices may be generated for different types of process data. In the foregoing description, there was described a case where one sensing result is input as process data for one piece of equipment or one facility. In the case where various types of sensing results are input, a 2D matrix may be generated for each, a 3D matrix may be generated by accumulating 2D matrices, and they are compared to derive a state score. In order to simplify vector calculation in this manner, multiple vectors having the same property are expressed in one matrix, and what is obtained by simplifying the matrix is called a “tensor.”

In a process data reception step S502, process data is received. In this case, the process data may refer to various types of sensor data received from various types of equipment or facilities 103 as described above. The process data may be the data input in real time to calculate the state of the equipment or facilities 130 in a current state.

In the process data reception step S502, a direct connection may be made to the equipment or facilities 103 over a network or the like, or data may be received from a sensor attached to the equipment or facilities 103. In some cases, a configuration may be made to receive data from a database where past data is accumulated and analyze a past state.

In a checking target matrix generation step S503, the received process data is periodically checked, and a 2D checking target matrix representative of the relationship between the data values of a current point in time and a previous point in time for each period is generated.

In the checking target matrix generation step S503, a 2D matrix may be generated in the same manner as in the normal-state matrix generation step S501, but the target data may be real-time process data collected in real time rather than normal-state process data. Through this, the differences between the process data input in real time and the normal-state process data may be quantified, and a state score may be derived accordingly.

Even when there is no separate description, the operation method of the normal-state matrix generation step S501 may be applied as a method of generating a 2D matrix in the checking target matrix generation step S503 without change.

In a state score derivation step S504, a state score is derived by calculating a value representative of the difference between the normal-state matrix and the checking target matrix. Through this, the difference between the matrix generated with the normal-state process data and the matrix generated for the process data input in real time is quantified. As the difference increases, the state may be viewed as being close to an abnormal state because it is considered to be different from a normal state, and it may be interpreted as having a high state score.

In order to quantify the difference between the normal-state matrix and the checking target matrix in the state score derivation step S504, various methods may be employed. The differences between the values of items at the same locations in the individual matrices may be simply added up or may be squared and then added up (the Euclidean distance), or other various methods may be applied thereto.

When the weight for each cell is calculated in the normal-state matrix generation step S504, the difference between the normal-state matrix and the checking target matrix is calculated by reflecting the calculated per-internal cell weight therein in the state score derivation step S504. A configuration may be made such that, when the weight for each cell is given, a case where the difference between cells having larger weights is larger has a larger state score. Through this, it may be possible to more accurately determine the state based on weights.

When 2D matrices for different types of process data are generated in the normal-state matrix generation step S501 and the checking target matrix generation step S503, respectively, a state score may be derived by adding up the differences between a normal-state matrix and a checking target matrix generated for respective types of process data in the state score derivation step S504. When various types of sensing data are input in this manner, a comprehensive state score may be generated using the matrix obtained by accumulating the various types of sensing data, and it may be possible to rapidly prepare for the risk state of a process.

The state score derivation method according to the present invention may be implemented as a program to be executed by a computer, and may be recorded on a computer-readable storage medium.

Examples of the computer-readable storage medium include magnetic media such as hard disks, floppy disks and magnetic tapes, optical storage media such as CDROMs and DVDs, magneto-optical media such as floptical disks, and hardware devices specially configured to store and execute program instructions, such as ROM, RAM, flash memory, and the like.

Examples of the program instructions include high-level language codes that can be executed by a computer using an interpreter or the like as well as machine language codes such as those produced by a compiler. Each of the hardware devices may be configured to act as one or more software modules to perform processing according to the present invention, and vice versa.

Although the present invention has been described with reference to the embodiments, those skilled in the art may variously modify and change the present invention without departing from the spirit and scope of the present invention described in the attached claims.

### INDUSTRIAL APPLICABILITY

The present invention is directed to a state score derivation system and method. There are provided a state score derivation system including: a normal-state matrix generation unit configured to receive process data in a normal state for a plurality of points in time and generate a two-dimensional (2D) normal-state matrix representative of the relationship between the data values of a current point in time and a previous point in time for each point in time; a process data reception unit configured to receive process data; a checking target matrix generation unit configured to periodically check the received process data and generate a 2D checking target matrix representative of the relationship between the data values of a current point in time and a previous point in time for each period; and a state score derivation unit configured to derive a state score by calculating a value representative of the difference between the normal-state matrix and the checking target matrix, and a method of operating the same.

What is claimed is:

1. A state score derivation system, comprising:
a normal-state matrix generation unit configured to receive process data in a normal state for a plurality of points in time and generate a two-dimensional (2D) normal-state matrix representative of a relationship between data values of a current point in time and a previous point in time for each point in time;
a process data reception unit configured to receive process data;
a checking target matrix generation unit configured to periodically check the received process data and generate a 2D checking target matrix representative of a relationship between data values of a current point in time and a previous point in time for each period; and
a state score derivation unit configured to derive a state score by calculating a value representative of a difference between the normal-state matrix and the checking target matrix.

2. The state score derivation system of claim 1, wherein the normal-state matrix generation unit and the checking target matrix generation unit:
determine sections, within which the data values of the current point in time and the previous point in time fall, among predetermined n sections; and
generate an n*n matrix with the section within which the data value of the current point in time falls and the section within which the data value of the previous point in time falls used as respective axes by using information about the sections within which the process data values of the current point in time and the previous point in time fall.

3. The state score derivation system of claim 2, wherein the normal-state matrix generation unit:
generates a plurality of pieces of sub-process data by dividing the plurality of points in time by a time unit;
generates a 2D normal-state sub-matrix for each of the pieces of sub-process data; and
calculates a weight for each intra-matrix cell by comparing the normal-state matrix and the plurality of normal-state sub-matrices, and
wherein the state score derivation unit:
calculates a difference between the normal-state matrix and the checking target matrix by reflecting the calculated weight for each intra-matrix cell therein.

4. The state score derivation system of claim 3, wherein the normal-state matrix generation unit calculates a difference between values of corresponding cells between the normal-state matrix and each of the plurality of normal-state sub-matrices, and calculates the weight for each cell so that as a deviation of the calculated difference between the values decreases, a higher weight is allocated.

5. The state score derivation system of claim 4, wherein the normal-state matrix generation unit and the checking target matrix generation unit generate 2D matrices for different types of process data, and
wherein the state score derivation unit derives a state score by adding up differences between a normal-state matrix and a checking target matrix generated for each type of process data.

6. A state score derivation method that operates in a state score derivation system equipped with a central processing unit and memory, the state score derivation method comprising:
a normal-state matrix generation step of receiving process data in a normal state for a plurality of points in time and generating a two-dimensional (2D) normal-state matrix representative of a relationship between data values of a current point in time and a previous point in time for each point in time;
a process data reception step of receiving process data;
a checking target matrix generation step of periodically checking the received process data and generating a 2D checking target matrix representative of a relationship between data values of a current point in time and a previous point in time for each period; and
a state score derivation step of deriving a state score by calculating a value representative of a difference between the normal-state matrix and the checking target matrix.

7. The state score derivation method of claim 6, wherein the normal-state matrix generation step and the checking target matrix generation step comprise:
determining sections, within which the data values of the current point in time and the previous point in time fall, among predetermined n sections; and
generating an n*n matrix with the section within which the data value of the current point in time falls and the section within which the data value of the previous point in time falls used as respective axes by using information about the sections within which the process data values of the current point in time and the previous point in time fall.

8. The state score derivation method of claim 7, wherein the normal-state matrix generation step comprises:
generating a plurality of pieces of sub-process data by dividing the plurality of points in time by a time unit;
generating a 2D normal-state sub-matrix for each of the pieces of sub-process data; and
calculating a weight for each intra-matrix cell by comparing the normal-state matrix and the plurality of normal-state sub-matrices, and
wherein the state score derivation step comprises:
calculating a difference between the normal-state matrix and the checking target matrix by reflecting the calculated weight for each intra-matrix cell therein.

9. The state score derivation method of claim 8, wherein the normal-state matrix generation step comprises calculating a difference between values of corresponding cells between the normal-state matrix and each of the plurality of normal-state sub-matrices, and calculating the weight for each cell so that as a deviation of the calculated difference between the values decreases, a higher weight is allocated.

10. The state score derivation method of claim 9, wherein the normal-state matrix generation step and the checking target matrix generation step comprise generating 2D matrices for different types of process data, and
wherein the state score derivation step comprises deriving a state score by adding up differences between a normal-state matrix and a checking target matrix generated for each type of process data.

11. A non-transitory computer-readable storage medium having recorded thereon a program for causing a computer to execute the method of claim 6.
